(19) United States
(12) Patent Application Publication
(10) Pub. No.: US 2014/0036859 A1
(43) Pub. Date: Feb. 6, 2014

(54) Methods to Increase Sounding Capacity for LTE-Advanced Systems

(71) Applicants: Anthony Ekpenyong, Farmers Branch, TX (US); Vikram Chandrasekhar, Dallas, TX (US); Runhua Chen, Dallas, TX (US); Pierre Bertrand, Antibes (FR)

(72) Inventors: Anthony Ekpenyong, Farmers Branch, TX (US); Vikram Chandrasekhar, Dallas, TX (US); Runhua Chen, Dallas, TX (US); Pierre Bertrand, Antibes (FR)

(73) Assignee: TEXAS INSTRUMENTS INCORPORATED, Dallas, TX (US)

(21) Appl. No.: 13/004,512

(22) Filed: Jan. 11, 2011

Related U.S. Application Data
(60) Provisional application No. 61/293,915, filed on Jan. 11, 2010.

(51) Int. Cl. H04W 72/04

(52) U.S. Cl. CPC H04W 72/042
USPC 370/330

(57) ABSTRACT

This invention is a method of wireless communication between a base station and at least one user equipment. The base station signals a user equipment to produce a burst of a number of sounding reference signals having a predetermined burst duration. The user equipment sounds wireless channel to the base station via a burst of sounding reference signals having the predetermined burst duration. The base station schedules transmission of user equipment in time and frequency domain according to a CQI estimated from the received sounding reference signals.

### CLAIM OF PRIORITY

This application claims priority under 35 U.S.C. 119(e) (1) to U.S. Provisional Application No. 61/293,915 filed Jan. 11, 2010.

### TECHNICAL FIELD OF THE INVENTION

The technical field of this invention is wireless communication such as wireless telephony.

### BACKGROUND OF THE INVENTION

Sounding Reference Signal (SRS) transmission enables time and frequency dependent scheduling and has been adopted as a feature in Evolved Universal Terrestrial Radio Access (E-UTRA) for Revision 8 and beyond. The channel quality indicator (CQI) estimate obtained from sounding can be expired or stale because of the inevitable time delay between channel sounding and the follow-up scheduled transmission. This is more pronounced for faster user equipment (UE). Thus faster UE needs to have more frequent sounding in order to maintain the fresh CQI at the base station (eNB). For example a UE with a Doppler of 200 Hz experiences a different propagation channel every fifth sub-frame because the sub-frame rate is 1000 Hz. In such case for channel adaptive modulation and coding (AMC) to be performed, UE 109 must sound nearly every sub-frame or every other sub-frame. The objective of maintaining a fresh CQI at eNB 101 may be impossible for very fast UEs having a Doppler of 200 Hz or more because the channel can change substantially between sub-frames. Slower UEs naturally ought to sound less frequently. As UE 109 speed increases, the sounding period should reduce up to a point. Very fast UEs should abandon the goal of maintaining a fresh CQI and sound less frequently.

### SUMMARY OF THE INVENTION

This invention is a method of wireless communication between a base station and at least one user equipment. The base station signals a user equipment to produce a burst of a number of sounding reference signals having a predetermined burst duration. The user equipment sounds the wireless channel to the base station via a burst of sounding reference signals having the predetermined burst duration. The base station schedules transmission of user equipment in time and frequency domain according to Channel State Information (CQI) estimated from the received sounding reference signals.

### BRIEF DESCRIPTION OF THE DRAWINGS

These and other aspects of this invention are illustrated in the drawings, in which:

FIG. 1 illustrates an exemplary prior art wireless communication system to which this application is applicable;

FIG. 2 shows the Evolved Universal Terrestrial Radio Access (E-UTRA) Time Division Duplex (TDD) frame structure of the prior art;

FIG. 3 illustrates operation of an aspect of the invention showing sounding bursts;

FIG. 4 illustrates an example of frequency hopping according to this invention;

FIG. 5 illustrates a first exemplary control element coding format for aperiodic sounding from one antenna port using a MAC control element;

FIG. 6 illustrates a second exemplary control element coding format for aperiodic sounding from two antenna ports using a MAC control element;

FIG. 7 illustrates a manner of increasing sounding resources by adding an additional, low duty cycle, sounding symbol; and

FIG. 8 is a block diagram illustrating internal details of a base station and a mobile user equipment in the network system of FIG. 1 suitable for implementing this invention.

### DETAILED DESCRIPTION OF PREFERRED EMBODIMENTS

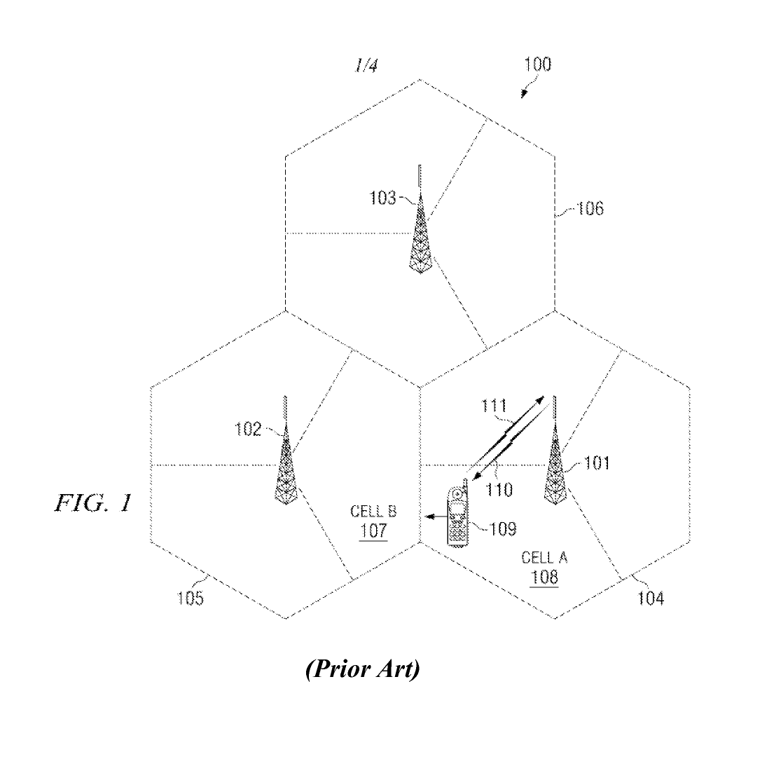

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 (eNB) are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of up-link 111 time or frequency or code resources. If UE 109 has data ready for transmission, which may be traffic data, measurements report, tracking area update, UE 109 can transmit a random access signal on up-link 111. The random access signal notifies base station 101 that UE 109 requires up-link resources to transmit the UEs data. Base station 101 responds by transmitting to UE 109 via down-link 110, a message containing the parameters of the resources allocated for UE 109 up-link transmission along with a possible timing error correction. After receiving the resource allocation and a possible timing advance message transmitted on down-link 110 by base station 101, UE 109 optionally adjusts its transmit timing and transmits the data on up-link 111 employing the allotted resources during the prescribed time interval.

Base station 101 configures UE 109 for periodic uplink sounding reference signal (SRS) transmission. Base station 101 estimates uplink channel quality information (CSI) from the SRS transmission.

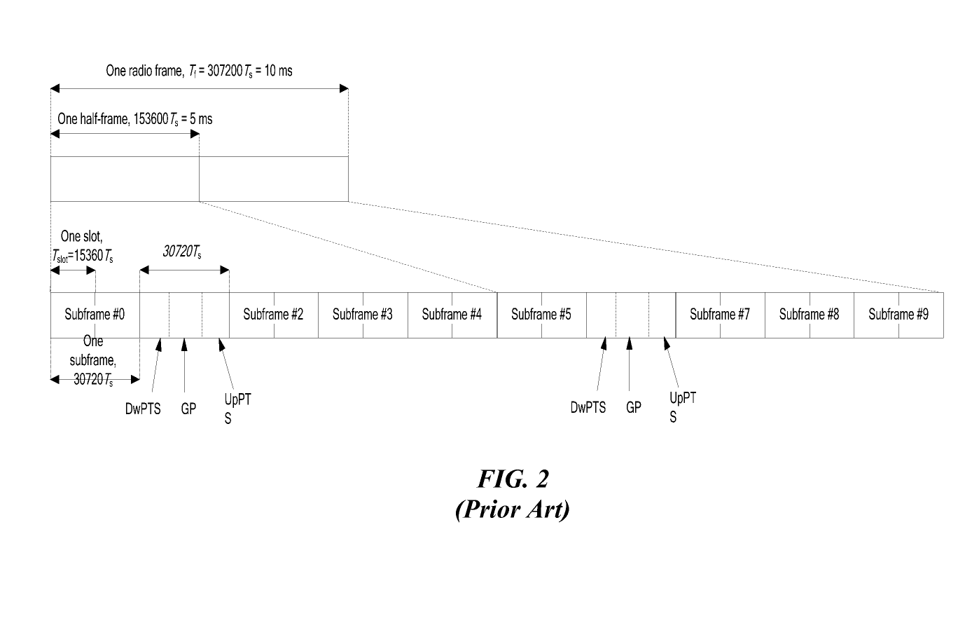

FIG. 2 shows the Evolved Universal Terrestrial Radio Access (E-UTRA) time division duplex (TDD) Frame Structure. Different subframes are allocated for downlink (DL) or uplink (UL) transmissions. Table 1 shows applicable DL/UL subframe allocations.

TABLE 1

| | Switch-point | Sub-frame number | | | | | | | | | |
|---|---|---|---|---|---|---|---|---|---|---|---|
| Configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

Third Generation Partnership Project (3GPP) TR 25.913 for Evolved Universal Terrestrial Radio Access (E-UTRA) and Evolved Universal Terrestrial Radio Access Network (E-UTRAN) requires that the Rel-8 Long Term Evolution (LTE) system supports at least 200 active users without discontinuous reception (DRX) in a 5 MHz bandwidth. The Rel-8 sounding resources were provisioned with this number in mind to support frequency dependent channel scheduling, power control, and timing estimation. On the other hand TR 36.913 specifies that the LTE-Advanced system should support at least 300 active users without DRX in a 5 MHz bandwidth. This is a 50% increase over the Rel-8 requirement even without considering the LTE-Advanced features of uplink (UL) Single-User Multiple Input, Multiple Output (SU-MIMO), non-contiguous Physical Uplink Shared CHannel (PUSCH) resource allocation, carrier aggregation, Coordinated Multi-point (CoMP) transmission and reception and heterogeneous networks. Thus it is imperative to determine if the LTE Rel-8 Sounding Reference Signal (SRS) design and multiplexing capacity is sufficient to support this number of active users with these LTE-A features.

LTE-A features have the following sounding requirements. UL SU-MIMO is non-precoded and uses antenna-specific SRS. Therefore, up to 4 times the resources of the Rel-8 requirement is required for up to four transmit antennas. UE implementing non-contiguous PUSCH resource allocation may need to sound over wider bandwidths than the minimum sounding bandwidth of 4 Resource Blocks (RBs) if contiguous sounding is desired. When using channel reciprocity downlink (DL) Multi-User, Multiple Input, Multiple Output (MU-MIMO) or Single-User, Multiple Input, Multiple Output (SU-MIMO) in Time Division Duplex (TDD) systems accurate sounding is required when channel to compute long term channel statistics. CoMP sounding should be reliably received at all cells in a cooperating set. This requires coordination of sounding resources between cooperating cells in order to avoid or mitigate inter-cell interference. It may be desirable to specify different sounding configurations for multiple component carriers (CCs) during Carrier Aggregation. In addition the effectiveness of sounding at higher Doppler frequencies should be verified due to aggregating CCs at higher frequency bands. Similarly to CoMP there is the need for SRS coordination when using Heterogeneous networks to mitigate inter-cell interference caused by the unplanned deployment and self-configuration features of femto cells.

Therefore a pressing issue is that of increased resources, particularly for UL SU-MIMO. Sounding capacity can be fairly approximated by the expression:

$$SRS Capacity = \frac{System SRS BW}{UE Specific SRS BW} \times {N}_{cs} \times {N}_{c} \times \frac{UE Specific SRS Periodicity}{Cell Specific Subframe Configuration Period} ,$$

where: N_{CS} is the number of cyclic shifts; and N_{C} is the number of frequency combs. Thus for a 10 km/h single antenna UE in a Typical Urban (TU) channel with a sounding period of 10 ms, N_{CS}=4, cell subframe period of 1 ms and 5 MHz bandwidth, 240 UEs can be supported for narrowband (4 RBs) sounding and 80 UEs can be supporter for wideband (24 RBs) sounding. Clearly, some enhancements are needed to meet the LTE-Advanced requirements and the additional features of LTE-A features enumerated above. A brief description of a number of proposals increasing and/or more efficiently managing the Rel-8 sounding resources in order to support LTE-Advanced appears below with the merits and demerits of each proposal.

Sounding capacity can be increased by re-using all uplink reference signals wherever possible. This is already supported by Rel-8 and is left to eNB implementation. For example, the Physical Uplink Control CHannel Reference Signal (PUCCH-RS) can be used to obtain long term channel statistics for precoding, while the Physical Uplink Shared CHannel Reference Signal (PUSCH-RS) may provide more accurate channel estimation in a particular UpLink (UL) Resource Block (RB) allocation compared to the Sounding Reference Signal (SRS). Note that obtaining channel state information from the PUSCH is limited to the PUSCH allocation for the UE.

A different non-backward compatible procedure is to piggyback a UE for sounding purposes in the Demodulation Reference Signal (DMRS) region of an UL grant allocated to a different UE. By pairing UEs as in MU-MIMO, the sounding (or secondary) UE can be signaled a Modulation and Coding Scheme (MCS) value with zero payload size to indicate that sounding is required. The main advantage of re-using the DMRS is that there is no impact on SRS resources in Rel-8/Rel-9 specification. However this means that the piggybacked UE must be an LTE-A UE since the behavior of an LTE (Rel-8/Rel-9) UE is not specified for reception of a zero-payload MCS value. Since there are two DMRS symbols in one subframe two sounding resources are available per UL grant. However the secondary UE cannot be allocated a separate UL grant for PUSCH transmission in the same subframe while maintaining single carrier transmission.

Sounding by piggybacking the PUSCH-RS does not come without cost. This sounding is dependent on the availability of control channel elements (CCE) resources for dynamically signaling the UL grants in the common or UE dedicated search space. Note also that L1/L2 signaling is necessary for each subframe where sounding is required. Therefore, the gain obtained from the increased sounding resources is offset by the increased L1/L2 signaling overhead. This could result in increased Physical Downlink Control CHannel (PDCCH) blocking probability.

In another method the Sounding Reference Signal (SRS) is dynamically scheduled for one shot transmission using an activation Information Element (IE) in the Downlink Control Information (DCI) format(s) scheduling PUSCH transmission. This is similar to the one-shot, aperiodic Channel Quality Indicator (CQI) report in Rel-8, which is also activated by an IE in DCI format 0 for scheduling PUSCH transmission. This dynamic SRS activation allows a UE to simultaneously transmit SRS from multiple antennas as well as activate and release SRS resources in response to changing channel and traffic conditions. SRS reconfiguration is further useful for de-activating sounding from additional antennas if channel, traffic or other UE-specific conditions such as antenna gain imbalance dictate a fallback to single antenna transmission mode.

This method provides for efficient management of Rel-8 sounding resources. This technique can configure the L2 scheduler can configure sounding in response to changing traffic and/or channel conditions. This technique does not address the question of inadequacy of Rel-8 sounding resources for the LTE-Advanced requirement stated in TR 36.913. Dynamic SRS activation and re-configuration could incur a significant increase in L1/L2 control signaling overhead similar to the piggybacked DMRS technique.

Dynamically scheduled SRSs include the following drawbacks. This technique reduces PDCCH capacity and thus L2 signaling may be required solely for sounding. This SRS activation scheme implies than a UE with multiple transmit antennas is first transmitted in 1-antenna-port mode. This then needs to be promoted to MIMO transmission due to a change in channel or traffic conditions. The eNB adds an SRS activation IE to the UL grant it was going to send to the UE. Once the UE sounds (one-shot SRS) it can then be scheduled for MIMO. There are two weaknesses with this scenario. Firstly, the UE cannot immediately be scheduled for MIMO because Radio Resource Control (RRC) signaling is required to re-configure the UE to the MIMO transmission mode. Because RRC signaling is needed to configure the UE for MIMO then RRC signaling can also be used to (re)-configure resources for sounding from additional antennas. Secondly, there is no waste in PDCCH resources if and only if the eNB was already planning to allocate UL grants to UE(s) for which sounding is also required from additional antennas. It is likely that some UEs would be scheduled only after sounding. Therefore, additional PDCCH resources are required solely for sounding. Independent power control for each transmit antenna is being considered because of possible antenna gain imbalance. It may be difficult to use aperiodic sounding to control transmit power from multiple antennas when using independent power control because of the aperiodic (one-shot) nature of this sounding. The SRS could be used for channel reciprocity in the DL of TDD systems. Exploiting channel reciprocity by beamforming is limited to instances when aperiodic sounding from multiple antennas is scheduled.

The next prior art technique increases the cyclic shift or Repetition Factor (RPF). In Rel-8 at most 8 cyclic shifts can be supported per Sounding Reference Signal Bandwidth (srsBandwidth) and frequency comb depending on the maximum delay spread seen in the cell. A two-fold increase in sounding resources can be obtained by increasing the number of cyclic shifts to 16. This requires an additional bit for signaling the UE-specific cyclic shift nₛᵣₛ^{cs}. This option would reduce the minimum cyclic shift separation by a factor of two and would only be applicable for low delay spread channels. A similar impact on delay spread is seen by increasing the RPF from 2 to 4.

Another prior art technique increases the sounding overhead. Adding one more Single Carrier Frequency Division Multiple Access (SC-FDMA) symbol for sounding provides a 100% increase in sounding resources. However, this gain comes at the cost of increasing the SRS overhead. This technique is not backward compatible because transmitting in any other symbol apart from the last symbol of a subframe will interfere with Rel-8 PUSCH transmissions.

With the issue of PDCCH resources in mind, another proposed prior art technique introduces a new DCI format similar to DCI 3/3A for scheduling a group of UEs for one-shot SRS transmission. This technique mitigates the impact on PDCCH capacity for dynamic scheduling of SRS grants when compared to dynamic scheduling on the DCI formats used for PUSCH allocation. However since dynamic scheduling is by nature a one-shot allocation there is the potential to trigger too many one-shot SRS grants. Thus if a UEs sounding period is 10 ms and a traffic burst occurs for 100 ms, then the eNB has to schedule 10 SRS grants. A more efficient scheme would configure an SRS activation grant including the sounding resources, periodicity and a timer or duration for the period when the sounding is active. The duration could be configured to be the same as the traffic burst duration.

Two other options include increasing the sounding period (latency) to support two or four transmit antennas and a new SRS sequence design. Increasing the sounding period limits the velocity range for frequency-dependent scheduling. A new sequence design is not desirable given the significant impact to the current LTE specification.

One aspect of this invention reduces signaling overhead using semi-persistent scheduling. The main problem with scheduled SRS and piggybacked DMRS is incurring significant L1/L2 signaling overhead. Rather than dynamic signaling in every subframe, semi-persistent scheduling is used for setup/release of SRS/DMRS resources for channel sounding. Using this signaling to piggybacked DMRS, the eNB can semi-persistently schedule a UE to sound the channel using the DMRS symbols on a specific RB allocation. For example, a 2 transmit antenna (Tx) UE can sound on antenna 1 in the DMRS symbol of the first slot and sound on antenna 2 in the DMRS symbol of the second slot of a subframe. This can be similarly used for setup and release of SRS resources. In the same manner the SRS/DMRS resources can be de-activated and re-assigned to another UE using a semi-persistent grant release procedure.

This invention mitigates the impact of dynamic L1/L2 control signaling for sounding activation using timer-enabled SRS bursts. The main idea is to schedule SRS bursts where the burst duration is configurable by the network. This technique is more dynamic than the one-shot SRS currently in the specification. This invention proposes semi-persistent scheduling for setup/release of SRS/DMRS resources for channel sounding as an alternative to dynamic signaling in every subframe. In another embodiment the SRS burst activation signal can be sent in an UL grant scheduling data transmission on the Physical Uplink Shared Channel (PUSCH).

In this invention higher layer signaling configures the UE for SRS bursts. Table shows 2 an example for the case of UL SU-MIMO with 2 Tx UEs. Table 2 shows a few additional fields are added to the SRS IE to configure scheduled SRS bursts.

TABLE 2

| Field | Value | Remarks |
|---|---|---|
| transmissionComb2 | {0, 1} | Same as Rel-8/Rel-9 |
| cyclicShift2 | {cs0, cs1, . . . , cs7} | Same as Rel-8/Rel-9 |
| burstDuration | {e5, e10, e20, e40} | Release after e* |
| | | transmissions |

In the burstDuration field a value of e5 denotes that the SRS burst lasts for 5 SRS transmissions where the periodicity of transmission is T_{SRS} may be the same as the UE-specific sounding period in Rel-8 or may be a different value specifically for aperiodic SRS denoted as T_{SRS-ap}. In another embodiment the burst duration field may include values e1 and e2, wherein e1 indicates a single-shot SRS transmission and e2 indicates a dual shot SRS transmission. This invention includes two methods for activating the SRS bursts at the UE: semi-persistent scheduling; and RRC signaling.

Semi-persistent scheduling permits minimal changes to the Rel-8 specification by conveying the start of the SRS burst to the UE using an SPS activation PDCCH of DCI format 0 or a new DCI format for scheduling UL SU-MIMO PUSCH transmission. The CRC of DCI format 0 is masked with the SPS Cell-Radio Network Temporary Identifier (C-RNTI). This is applicable for sounding using SRS resources and DMRS resources. Some field values in the PDCCH validation procedures of Tables 9.2-1 and 9.2-1A of 3GPP, TR 36.213 v.8.8.0 are re-defined to validate semi-persistently scheduled sounding to distinguish such a sounding grant from a Rel-8 semi-persistent PUSCH grant. An exemplary scheme sets the cyclic shift value in Tables 9.2-1 and 9.2-1A of 3GPP, TR 36.213 v.8.8.0 to “111” compared to “000” for normal SPS activation/release. This does not necessarily imply that n_{DMRS}⁽²⁾=9 in the DMRS procedure of Table 5.5.2.1.1-1 of 3GPP, TR 36.211 v.8/8.0. For example where the UE is piggybacked with another UE to form a MU-MIMO pair, a different mapping scheme can be used to ensure maximum cyclic shift separation between the Constant Amplitude Zero Auto-Correlation (CAZAC) sequences used by each UE. Alternatively a new SRS C-RNTI can be used to mask the CRC of DCI format 0 for sounding using SRS resources. Employing the SRS C-RNTI enables grouping many UEs in the same activation message.

It is also possible to divide the sounding bandwidth into different bandwidth parts of multiple RBs. In one example each bandwidth part could be made up of 4 RBs. The sounding UE can then sound on one bandwidth part in one subframe and then cyclically hop to the other bandwidth part in other subframes. The period for cyclically hopping through the total sounding bandwidth depends on the Doppler frequency of the UE and on the duration of the SRS burst.

There is a potential problem with this scheme for piggybacked DMRS. The piggybacked sounding UE is semi-persistently scheduled before a primary UE is dynamically scheduled for PUSCH transmission in one subframe. If the sounding bandwidth is not the same length in RBs as the PUSCH allocation the DMRS sequences from the sounding UE and the primary UE are not orthogonal. This restricts eNB scheduling, where the primary UE must have the same RB allocation as the sounding UE. If the sounding UE is scheduled with a 4 RB allocation the eNB must schedule a primary UE that can efficiently support 4 RBs in each subframe until the release of the SRS burst.

One solution to this problem employs orthogonal cover codes (OCC) across the two time slots of a subframe. This maintains orthogonality across UEs but precludes the use of intra-subframe frequency hopping. This problem may still apply when using OCC piggybacked sounding because when scheduling cell edge UEs in a fully loaded cell it is unlikely that a cell edge UE will get an UL grant of more than 4 RBs. The size of the sounding grant can be chosen based on the minimum scheduling unit selected by the MAC scheduler in order to maximize the PDCCH capacity.

The SPS sounding of this invention reduces the impact on L1/L2 signaling since only one activation PDCCH is required. In another embodiment of this method the SRS burst can be triggered by piggybacking an aperiodic SRS request in the DCI format scheduling uplink data transmission on the Physical Uplink Shared CHannel (PUSCH). These activation methods permit configuration of the burst duration based on traffic and channel dynamics as well as averaging period when the sounding is used for timing estimation and power control. These methods also permit configuration of the burst duration to enable DL beamforming based on channel reciprocity in TDD systems.

The second method uses Radio Resource Control (RRC) signaling to configure and activate SRS bursts. In a manner similar to SPS sounding the SRS burstDuration in Table 2 defines how many consecutive SRS transmissions can be sent in a burst. The difference with respect to SPS sounding is that in RRC signaling the base station can configure a different SRS periodicity for the SRS burst.

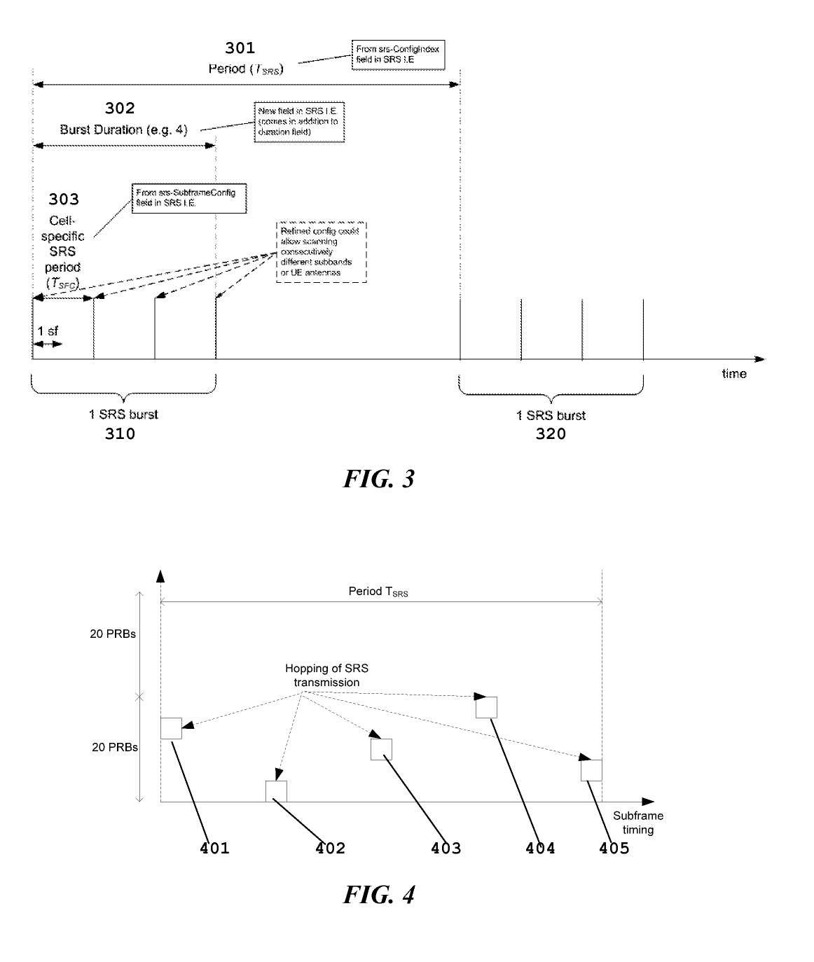

FIG. 3 illustrates operation of this aspect of the invention. FIG. 3 illustrates two SRS bursts 310 and 320. There is a time period T_{SRS} 301 between SRS bursts 310 and 302. Each SRS burst has a burst duration 302. FIG. 3 illustrates an example where burst duration 302 is 4 SRS transmissions. Included within each SRS burst 310 and 320 are plural cell specific SRS periods T_{SFC} 303.

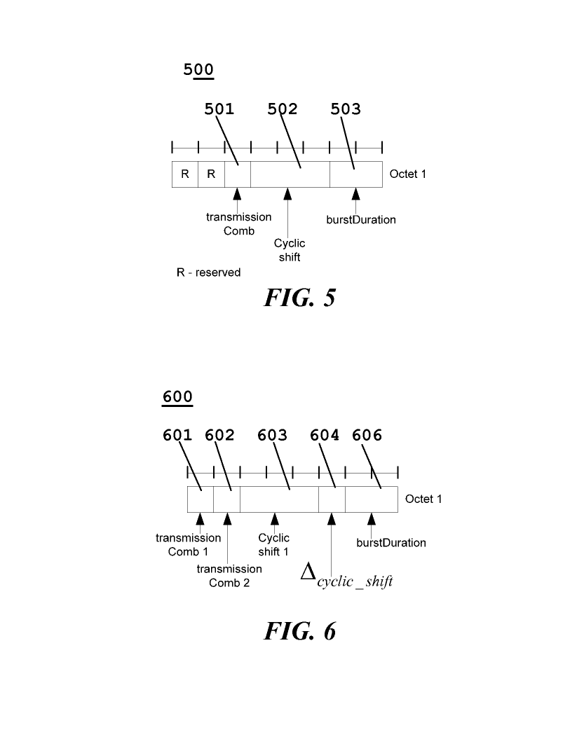

FIG. 3 shows the SRS could repeat every cell-specific SRS subframe period (T_{SFC}) 303 within a burst. This allows the base station to configure a set of closely spaced SRS transmissions in order to improve channel estimation for timing estimation or UL power control. This flexible configuration could also be used in other ways. Specifying an additional hopping parameter in the SRS IE, permits the UE to hop to different subbands for each transmission instance during the burstDuration window instead of repeating the same SRS in one subband. FIG. 4 illustrates such frequency hopping. FIG. 5 illustrates SRS transmissions 401, 402, 403, 404 and 405 shifting around within the Physical Resource Blocks (PRBs) during the subframe timing within the time of periodicity T_{SRS}. This provides the eNB with instant snapshots of (CSI) estimations across multiple subbands. A specified hopping parameter for antenna hopping for UL SU-MIMO permits the UE to transmit the same SRS from different antennas. This provides the eNB with an instant snapshot of CSI estimations across its antennas.

For some applications the latency associated with RRC signaling may be too high. L2 signaling may be employed for dynamic SRS activation. A Medium Access Control (MAC) control element may be defined for SRS activation similar to Component Carrier (CC) activation and deactivation for carrier aggregation. An SRS MAC control element can be piggy-backed on the PDSCH assigned to a UE for which sounding is required.

In contrast to RRC signaling of the additional fields of the SRS IE listed in Table 2, the MAC control element can be used to simultaneously provide a sounding resource and activate the UE for sounding. FIG. 5 illustrates an exemplary control element format for aperiodic sounding from one antenna port using a MAC control element. The control element octet 1 500 consists of a single byte. Two bits are reserved. Field 501 is 1-bit field indicating the transmission comb. Field 502 is a 3-bit field indicating the cyclic shift. Field 503 is a 2-bit field indicating the burst duration.

FIG. 6 shows another exemplary control element format. The control element formation of FIG. 6 is used when two antenna ports are activated for sounding. The control element octet 1 600 consists of a single byte. Fields 601 and 602 are respective 1-bit fields indicating transmission comb 1 and transmission comb 2. Field 603 is a 3-bit field indicating the cyclic shift. Field 604 is a 1-bit field indicating the differential cyclic shift value Δ_{cyclic}_{_{—}}_{shift}. This is used to determine the cyclic shift of the second antenna port as an offset relative to the cyclic shift of the first antenna port. Field 605 is a 2-bit field indicating the burst duration. Another embodiment adds another data byte if other sounding parameters need to be signaled. Other possibilities for activating sounding using a MAC control element are not excluded.

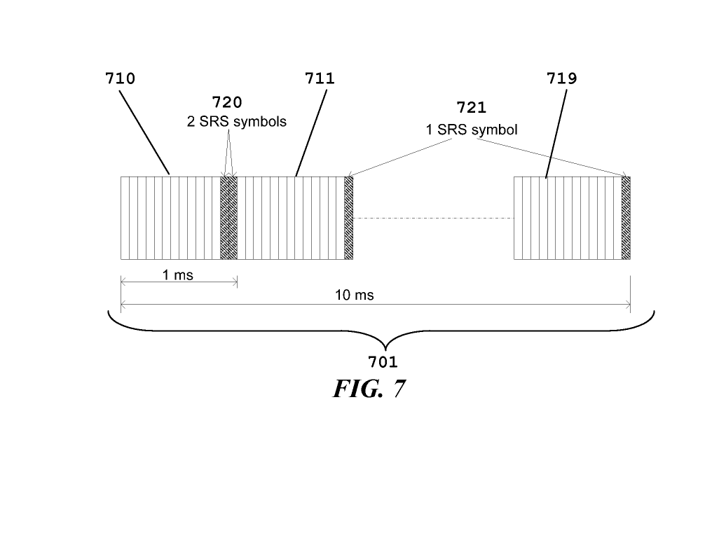

Another aspect of this invention increases the SRS capacity by adding an additional, low duty cycle, sounding symbol. This is similar to configuring two SC-FDMA sounding symbols in the Uplink Pilot Transmit Slot (UpPTS) region of TD-LTE systems. The location and periodicity of the additional sounding symbol is cell specific. One use-case for this technique is UL SU-MIMO, where UEs are expected to be in low to medium mobility environments. For example a 10 km/h UE can be configured with a minimum SRS periodicity of 10 ms. The LTE Rel-8 sounding specification allows multiplexing of UEs with different speeds by using the UE-specific SRS configuration index Iₛᵣₛ which determines the SRS periodicity Tₛᵣₛ and subframe offset configuration T_{offset}. For low mobility UEs a second sounding symbol can be added to their sounding subframes. This is illustrated in FIG. 7 for Iₛᵣₛ=7, Tₛᵣₛ=10, T_{offset}=0. FIG. 7 illustrates a 10 ms frame 701 including plural 1 ms subframes 710, 711 to 719. First subframe 710 has two sounding symbols 720 while other subframes 711 to 719 have only one sounding symbol 721 similar to Rel-8. A 2 Tx UE configured for UL SU-MIMO can sound on antenna 1 in the thirteenth symbol and on antenna 2 in the fourteenth symbol of a normal Cyclic Prefix (CP) subframe. The effective sounding overhead increases from 7.14% (corresponding to 10 sounding symbols in 1 radio frame) to 7.86% (corresponding to 11 sounding symbols in 1 radio frame). This increases sounding resources results 10% while increasing the effective sounding overhead from 7.14% to 7.86%. For two subframes with two sounding symbols within a radio frame there is a 20% increase in sounding resources with an effective sounding over head of 8.57% (corresponding to 12 sounding symbols in 1 radio frame).

This is not a backward-compatible technique. This technique may cause interference to PUSCH transmissions from LTE UEs. There are two solutions to this problem depending on whether the component carrier (CC) is backward compatible or not. With a backward compatible CC the first solution uses eNB scheduling. The eNB allocates a portion of the system bandwidth only for LTE-A UEs. For a 10 MHz bandwidth the eNB could reserve the upper part of the bandwidth for LTE-A UEs while the lower part is used by LTE-UEs. For a non-backward compatible CC the eNB scheduled all LTE-A UEs for PUSCH transmission in a subframe containing this second sounding symbol would puncture out their PUSCH transmissions for this sounding symbol.

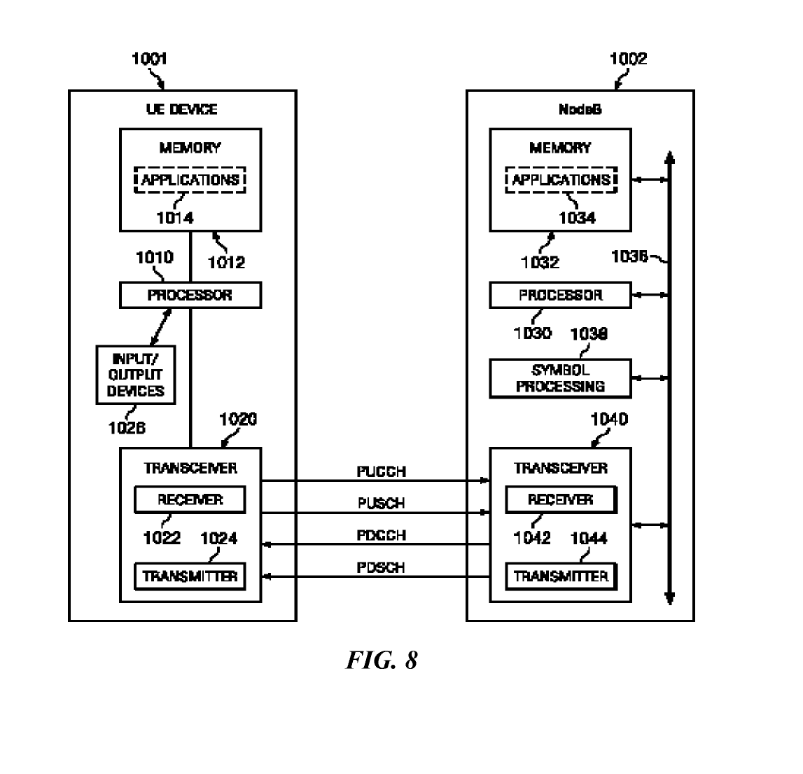

FIG. 8 is a block diagram illustrating internal details of an eNB 1002 and a mobile UE 1001 in the network system of FIG. 1. Mobile UE 1001 may represent any of a variety of devices such as a server, a desktop computer, a laptop computer, a cellular phone, a Personal Digital Assistant (PDA), a smart phone or other electronic devices. In some embodiments, the electronic mobile UE 1001 communicates with eNB 1002 based on a LTE or Evolved Universal Terrestrial Radio Access Network (E-UTRAN) protocol. Alternatively, another communication protocol now known or later developed can be used.

Mobile UE 1001 comprises a processor 1010 coupled to a memory 1012 and a transceiver 1020. The memory 1012 stores (software) applications 1014 for execution by the processor 1010. The applications could comprise any known or future application useful for individuals or organizations. These applications could be categorized as operating systems (OS), device drivers, databases, multimedia tools, presentation tools, Internet browsers, emailers, Voice-Over-Internet Protocol (VOIP) tools, file browsers, firewalls, instant messaging, finance tools, games, word processors or other categories. Regardless of the exact nature of the applications, at least some of the applications may direct the mobile UE 1001 to transmit UL signals to eNB (base-station) 1002 periodically or continuously via the transceiver 1020. In at least some embodiments, the mobile UE 1001 identifies a Quality of Service (QoS) requirement when requesting an uplink resource from eNB 1002. In some cases, the QoS requirement may be implicitly derived by eNB 1002 from the type of traffic supported by the mobile UE 1001. As an example, VOIP and gaming applications often involve low-latency uplink (UL) transmissions while High Throughput (HTP)/Hypertext Transmission Protocol (HTTP) traffic can involve high-latency uplink transmissions.

Transceiver 1020 includes uplink logic which may be implemented by execution of instructions that control the operation of the transceiver. Some of these instructions may be stored in memory 1012 and executed when needed by processor 1010. As would be understood by one of skill in the art, the components of the uplink logic may involve the physical (PHY) layer and/or the Media Access Control (MAC) layer of the transceiver 1020. Transceiver 1020 includes one or more receivers 1022 and one or more transmitters 1024.

Processor 1010 may send or receive data to various input/output devices 1026. A subscriber identity module (SIM) card stores and retrieves information used for making calls via the cellular system. A Bluetooth baseband unit may be provided for wireless connection to a microphone and headset for sending and receiving voice data. Processor 1010 may send information to a display unit for interaction with a user of mobile UE 1001 during a call process. The display may also display pictures received from the network, from a local camera, or from other sources such as a Universal Serial Bus (USB) connector. Processor 1010 may also send a video stream to the display that is received from various sources such as the cellular network via RF transceiver 1020 or the camera.

During transmission and reception of voice data or other application data, transmitter 1024 may be or become non-synchronized with its serving eNB. In this case, it sends a random access signal. As part of this procedure, it determines a preferred size for the next data transmission, referred to as a message, by using a power threshold value provided by the serving eNB, as described in more detail above. In this embodiment, the message preferred size determination is embodied by executing instructions stored in memory 1012 by processor 1010. In other embodiments, the message size determination may be embodied by a separate processor/memory unit, by a hardwired state machine, or by other types of control logic, for example.

eNB 1002 comprises a Processor 1030 coupled to a memory 1032, symbol processing circuitry 1038, and a transceiver 1040 via backplane bus 1036. The memory stores applications 1034 for execution by processor 1030. The applications could comprise any known or future application useful for managing wireless communications. At least some of the applications 1034 may direct eNB 1002 to manage transmissions to or from mobile UE 1001.

Transceiver 1040 comprises an uplink Resource Manager, which enables eNB 1002 to selectively allocate uplink Physical Uplink Shared CHannel (PUSCH) resources to mobile UE 1001. As would be understood by one of skill in the art, the components of the uplink resource manager may involve the physical (PHY) layer and/or the Media Access Control (MAC) layer of the transceiver 1040. Transceiver 1040 includes at least one receiver 1042 for receiving transmissions from various UEs within range of eNB 1002 and at least one transmitter 1044 for transmitting data and control information to the various UEs within range of eNB 1002.

The uplink resource manager executes instructions that control the operation of transceiver 1040. Some of these instructions may be located in memory 1032 and executed when needed on processor 1030. The resource manager controls the transmission resources allocated to each UE 1001 served by eNB 1002 and broadcasts control information via the PDCCH.

Symbol processing circuitry 1038 performs demodulation using known techniques. Random access signals are demodulated in symbol processing circuitry 1038.

During transmission and reception of voice data or other application data, receiver 1042 may receive a random access signal from a UE 1001. The random access signal is encoded to request a message size that is preferred by UE 1001. UE 1001 determines the preferred message size by using a message threshold provided by eNB 1002. In this embodiment, the message threshold calculation is embodied by executing instructions stored in memory 1032 by processor 1030. In other embodiments, the threshold calculation may be embodied by a separate processor/memory unit, by a hardwired state machine, or by other types of control logic, for example. Alternatively, in some networks the message threshold is a fixed value that may be stored in memory 1032, for example. In response to receiving the message size request, eNB 1002 schedules an appropriate set of resources and notifies UE 1001 with a resource grant.

What is claimed is:

1. A method of wireless communication between a base station and at least one user equipment including the steps of:
the base station signaling a user equipment to produce a burst of a number of sounding reference signals, said signaling setting a predetermined burst duration;
the user equipment sounding the base station via a burst of sounding reference signals having the predetermined burst duration; and
the base station scheduling transmission of user equipment in time and frequency domain according to received sounding reference signal.

2. The method of claim 1, wherein:
said step of the base station signaling a user equipment includes signaling a field specifying one of a plurality of predetermined burst durations.

3. The method of claim 2, wherein:
said plurality of predetermined burst durations include 5 transmissions, 10 transmissions, 20 transmissions and 40 transmissions.

4. The method of claim 2, wherein:
said plurality of predetermined burst durations include 1 transmission, 2 transmissions, 5 transmissions, 10 transmissions, 20 transmissions and 40 transmissions.

5. The method of claim 1, wherein:
said step of the base station signaling a user equipment includes signaling a Semi-persistent Scheduling (SPS) aperiodic SRS activation via a Physical Downlink Control CHannel (PDCCH) of Downlink control information (DCI) format 0.

6. The method of claim 5, wherein:
said step of signaling a Semi-persistent Scheduling (SPS) activation employs Sounding Reference Signal (SRS) resources.

7. The method of claim 5, wherein:
said step of signaling a Semi-persistent Scheduling (SPS) activation employs Demodulation Reference Signal Sequence (DMRS) resources.

8. The method of claim 5, wherein:
said step of the base station signaling a user equipment masks the Cyclic Redundancy Check (CRC) of Downlink control information (DCI) format 0 with a Semi-persistent Scheduling (SPS) Cell-Radio Network Temporary Identifier (C-RNTI).

9. The method of claim 1, wherein:
said step of the base station signaling a user equipment includes redefining a cyclic shift value from “000” for a normal Semi-persistent Scheduling (SPS) activation/release to “111” to distinguish the sounding grant from a semi-persistent Physical Uplink Shared CHannel (PUSCH) grant.

10. The method of claim 1, wherein:
said step of the base station signaling a user equipment includes signaling a Semi-persistent Scheduling (SPS) burst in a new Downlink control information (DCI) format scheduling a of Multiple Input, Multiple Output (MIMO) Physical Uplink Shared CHannel (PUSCH) transmission.

11. The method of claim 10, wherein:
said step of signaling a Semi-persistent Scheduling (SPS) aperiodic SRS activation employs Sounding Reference Signal (SRS) resources.

12. The method of claim 10, wherein:
said step of signaling a Semi-persistent Scheduling (SPS) activation employs Demodulation Reference Signal Sequence (DMRS) resources.

13. The method of claim 1, further comprising the step of:
pairing the user equipment with a second user equipment to form a Multiuser, Multiple Input, Multiple Output (MU-MIMO) pair; and
said step of the base station signaling a user equipment includes employing a different mapping scheme for the user equipment and the second user equipment to ensure maximum cyclic shift separation between the Constant Amplitude Zero Auto-Correlation (CAZAC) sequences used by the user equipment and the second user equipment.

14. The method of claim 1, further comprising the steps of:
the base station configuring the user equipment to sound on a first bandwidth part in a first subframe and then cyclically hop to a second different bandwidth part in a second different subframe employing orthogonal cover codes (OCC) across two time slots of a subframe, thereby cyclically hopping through sounding bandwidth dependent upon a Doppler frequency of the user equipment.

15. The method of claim 1, wherein:
said step of the base station signaling a user equipment includes employing Radio Resource Control (RRC) signaling to configure and activate SRS bursts.

16. The method of claim 15, wherein:
said step of the base station signaling a user equipment includes configuring a different Sounding Reference Signal (SRS) periodicity for the Sounding Reference Signal (SRS) burst.

17. The method of claim 16, wherein:
the user equipment is configured with a hopping parameter; and
the user equipment hops to different subbands for each transmission instance during the burst duration window according to the hopping parameter.

18. The method of claim 16, wherein:
the user equipment includes plural antennas for operation in Single-User Multiple Input, Multiple Output (SU-MIMO);
said step of the base station signaling a user equipment includes configuring the user equipment with a hopping parameter; and
the user equipment employing antenna hopping for transmitting the same Sounding Reference Signal (SRS) from different antennas according to the hopping parameter.

19. The method of claim 1, wherein:
said step of the base station signaling a user equipment includes employing L2 signaling including an octet having
one bit specifying a transmission comb,
three bits specifying a cyclic shift, and
two bits specifying the predetermined burst duration.

20. The method of claim 1, wherein:
said step of the base station signaling a user equipment includes employing L2 signaling including an octet having
one bit specifying a first transmission comb,
one bit specifying a second transmission comb,
three bits specifying a cyclic shift,
one bit specifying a cyclic of a second antenna relative to a cyclic shift of a first antenna, and
two bits specifying the predetermined burst duration.

21. The method of claim 1, wherein:
said step of the base station signaling a user equipment includes piggybacking an aperiodic SRS activation signal in a Physical Downlink Control CHannel (PDCCH) scheduling uplink data transmission on the Physical Uplink Shared Channel (PUSCH).
